(19) United States
(12) Patent Application Publication
(10) Pub. No.: US 2026/0001997 A1
(43) Pub. Date: Jan. 1, 2026

(54) SULFUR POLYMER

(71) Applicant: IDAHO STATE UNIVERSITY, POCATELLO, ID (US)

(72) Inventors: Courtney Jenkins, POCATELLO, ID (US); Caryn Evilia, POCATELLO, ID (US)

(21) Appl. No.: 19/250,797

(22) Filed: Jun. 26, 2025

Related U.S. Application Data
(60) Provisional application No. 63/664,357, filed on Jun. 26, 2024.

(51) Int. Cl. C08G 75/14; C08J 3/24; C09K 17/18

(52) U.S. Cl. CPC C08G 75/14; C08J 3/24; C09K 17/18; C08J 2381/04

(57) ABSTRACT

The present disclosure is generally directed to sulfur polymers and their method of formation. In embodiments of the present disclosure, a sulfur polymer comprising a polysulfide chain, an aliphatic group and a stabilizing group are described. In embodiments, a method for forming a sulfur polymer is described, the method comprising: heating a mixture comprising polysulfides, a crosslinking agent, a diallyl sulfide, a stabilizing agent and an aliphatic group.

### CROSS REFERENCE TO RELATED APPLICATION

This application claims filing benefit of U.S. Provisional Patent Application Ser. No. 63/664,357 having a filing date of Jun. 26, 2024, which is incorporated herein by reference for all purposes.

### FEDERAL RESEARCH STATEMENT

This invention was made with Government support under Contract No. 2337376, awarded by the National Science Foundation. The Government has certain rights in the invention.

### BACKGROUND

While demand for fossil fuels in energy is increasingly being supplanted by alternative energy sources, chemicals derived from petroleum remain an important constituent in many modern products, from toys to personal care products and medicines. As a by-product of the petrochemical refinement process, seven-hundred million tons of sulfur in the form of elemental sulfur are produced per year. While some efforts to valorize sulfur by-products have been successful, the supply of sulfur still greatly outstrips demand.

A potential use for sulfur byproducts is to be used as fertilizers. Common fertilizers are based primarily on NPK formulations—those primarily consisting of nitrogen, phosphorus and potassium. However, commercial agriculture also depletes soil of micronutrients, such as manganese, iron, sulfur and others. These micronutrients must be restored to depleted soil to maintain efficient crop growth. However, as of now, the methods for restoring sulfur content to soil have relatively poor sulfur availability. Thus, an intention of the present disclosure is to supply a low-cost sulfur formulation which can effectively deliver sulfur to the soil ecosystem.

### SUMMARY

The present disclosure is generally directed to sulfur polymers and methods of their formation. For instance, a sulfur polymer is described, the sulfur polymer comprising: a polysulfide chain, an aliphatic group, and a stabilizing group. Further, a method of the formation of the sulfur polymer is described, the method comprising heating a mixture comprising polysulfides, a crosslinking agent, a diallyl sulfide, a stabilizing agent, and an aliphatic group.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is an example structure of a portion of a sulfur polymer as disclosed herein;

FIG. 2A is a graph showing the water absorption % of sulfur polymers as disclosed herein when uncured.

FIG. 2B is a graph showing the water absorption % of sulfur polymers as disclosed herein for a 2-hour cure period;

FIG. 3A is a graph showing the water absorption % of sulfur polymers as disclosed herein for a 6-hour cure period.

FIG. 3B is a graph showing the water absorption % of sulfur polymers as disclosed herein for a 1 day cure period;

FIG. 4 is a graph showing the water absorption % of sulfur polymers as disclosed herein for a 2-day cure period;

FIGS. 5A-5D are SEM photographs of sulfur polymers of the present disclosure which were formed with or without porogens;

FIG. 5E is a graph showing the water absorption % of sulfur polymers as disclosed herein when formed with porogens;

FIG. 6 is a graph showing the cell growth fraction of P. aeruginoa when exposed to various sulfur polymers of the present disclosure; and

FIG. 7 is a series of bar graphs showing the weight loss of polymers of the present disclosure after exposure to P. aeruginosa.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment may be used in another embodiment to yield a still further embodiment.

As used herein, terms of approximation such as “generally,” “about,” or “approximately” include values within ten percent greater or less than the stated value. When used in the context of an angle or direction, such terms include within ten degrees greater or less than the stated angle or direction, e.g., “generally vertical” includes forming an angle of up to ten degrees either clockwise or counterclockwise with the vertical direction V.

The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components.

The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the term ‘swell’ and its grammatical derivatives may be used interchangeably with the term ‘water absorption.’ For instance, the swell % of a polymer is equivalent to the water absorption % of the polymer.

In general, the present disclosure is directed to sulfur polymers. The sulfur polymer of the present disclosure may be in the form of a copolymer. Disclosed herein are methods for synthesizing the sulfur polymer of the present disclosure. Further, methods of incorporating sulfur into a soil are provided.

The sulfur polymer of the present disclosure may comprise a polysulfide chain, an aliphatic group and a stabilizing group. The sulfur polymer may have a backbone comprising randomly alternating units of polysulfide chains and aliphatic groups. Additionally, the sulfur polymer may be crosslinked, through crosslinking at the junction of the polysulfide chain and aliphatic group. Thus, the sulfur polymer of the present disclosure may be described as a polymer having greater than two monomeric units, such as greater than 3 monomeric units, such as greater than 4 monomeric units.

Polysulfides are a class of chemicals which comprise a plurality of sulfur atoms bonded directly or indirectly together. For instance, a polysulfide may consist essentially of sulfur, or may contain a variety of small, organic linking groups. For instance, the polysulfide may comprise greater than 85 wt. % sulfur, such as greater than 90 wt. % sulfur. The presence of non-sulfur atoms in a polysulfide may be detected through a variety of methods including, but not limited to, nuclear magnetic resonance (NMR). In one embodiment, the polysulfide chain of the present disclosure may have a chemical structure of:

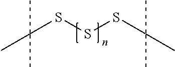

where n is from 1 to 6, such as 3 to 6, such as 4 to 6.

When used in the sulfur polymer of the present disclosure, the polysulfide chain may be in the form of a linear polysulfide.

The sulfur polymer may have a weight percent of the sulfur of greater than 15 wt. %, such as greater than 30 wt. %, such as greater than 40 wt. %. In embodiments, the sulfur polymer may have a weight percent of the sulfur from 10 wt. % to 65 wt. %, such as from 20 wt. % to 55 wt. %, such as from 30 wt. % to 40 wt. %, such as from 32 wt. % to 38 wt. %. In embodiments, the sulfur polymer may have a weight percent of sulfur of from 35 wt. % to 65 wt. %, such as from 40 wt. % to 55 wt. %. Further, the weight percent of sulfur in a sulfur polymer may be measured by using the dry weight of the sulfur polymer. Methods for measuring the wt. % of sulfur in a dry polymer are not particularly limited, but include x-ray fluorescence (XRF) and inductively-coupled plasma, optical emission spectroscopy (ICP-OES).

Furthermore, as mentioned previously, the sulfur polymer of the present disclosure may comprise an aliphatic group. The aliphatic group may be interspersed in the polymer chain between polysulfide chains. In embodiments, the aliphatic group may be a terminal group, i.e., bonded to one polysulfide chain. The aliphatic group may comprise units of styrene, ethylene, propylene, or mixtures thereof. Further, in embodiments, the aliphatic group may be hydrophilic. Such hydrophilic aliphatic groups include, but are not limited to, acrylamides, vinyl alcohols, acrylic acids, povidones or mixtures thereof.

In embodiments, the aliphatic units comprise acrylamide, such as methyl acrylamide.

In embodiments, the aliphatic group may be modified with a singular functional group or a plurality of functional groups. Such a functional group may comprise a carbonyl such as an amide, an ester, a thioester, an aldehyde or a ketone.

In general, the backbone of the aliphatic group may comprise carbon. In embodiments, the backbone of the aliphatic group may consist entirely of carbon. Nuclear magnetic resonance may be used to determine the elemental composition of the backbone of the aliphatic group. An aliphatic group having a backbone consisting essentially of carbon may have an NMR profile consisting of carbon-carbon bonds.

The aliphatic group may be present in the sulfur polymer at a weight percent of from 10 wt. % to 80 wt. %, such as from 15 wt. % to 65 wt. %, such as from 20 wt. % to 50 wt. %, such as from 25 wt. % to 45 wt. %. An example of an aliphatic group is shown below.

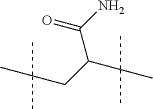

The sulfur polymer, in embodiments, may be crosslinked. The crosslinks may be formed of crosslinking groups, wherein the crosslinking groups may be bonded to the aliphatic group, or other polysulfide chains. The crosslinking groups are not particularly limited, but may comprise homobifunctional crosslinking groups. Alternatively, in embodiments, a heterobifunctional crosslinking group may be used.

Homobifuctional crosslinking groups may include methylbisacrylamide, ethylene glycol dimethacrylate, N,N′-Diallyl-L-tartardiamide (DATD), resols, epoxides. Heterobifunctional crosslinking groups include crosslinking groups that may form bonds with a variety of functional groups. For instance, a heterobifunctional crosslinking group may form bonds with an unsaturated carbon on the aliphatic group on one polymeric chain, and a carbonyl of aliphatic group on a different polymer chain.

In general, the crosslinking groups may be present in the sulfur polymer at a weight percent of from 10 wt. % to 40 wt. %, such as from 15 wt. % to 35 wt. %, such as from 20 wt. % to 30 wt. %. Further, the crosslinking groups may have a specific weight ratio with polysulfide chains in the sulfur polymer. Such a weight ratio may from 0.5 to 4, such as from 1 to 2. Without wishing to be bound to any particular theory, the weight percent of the crosslinking groups in the sulfur polymer, and thereby the degree of crosslinking, may be adjusted depending on the rigidity and water absorption potential of the desired polymer.

An example of a crosslinking group that may be used is shown below.

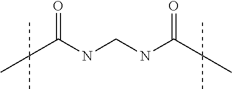

Without wishing to be bound to any particular theory, the present inventors have found that without the use of a stabilizing group, the crosslinking groups in the sulfur polymer may degrade, and the crosslinking group may crystallize out of the polymeric phase. Thus, an aspect of the present disclosure is the inclusion of a stabilizing group in the sulfur polymer, which can stabilize the crosslinking groups in the sulfur polymer. In general, stabilizing groups may comprise a monomer with intermediate polarity as compared to the polysulfide chains and aliphatic group/crosslinking group.

The stabilizing group may comprise dimethylacrylamide. An example of a stabilizing group may be found below.

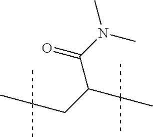

The stabilizing group may be present in the sulfur polymer at a weight percent from 5 wt. % to 30 wt. %, such as from 10 wt. % to 25 wt. %, such as from 15 wt. % to 20 wt. %. Further, as the stability of the crosslinking groups may be related to the stabilizing group, a specific weight ratio of the crosslinking groups to the stabilizing group in the sulfur polymer may be employed. Such a weight ratio may be from 1 to 4, such as from 1.5 to 3.5, such as from 2 to 3.

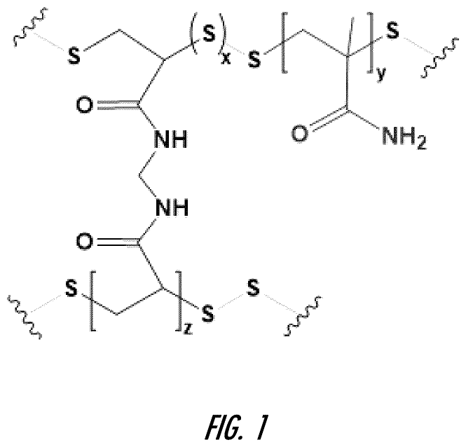

An example of the chemical structure of a portion of the sulfur polymer as described herein can be found in FIG. 1.

In embodiments of the present disclosure, the mixture comprises polysulfides, crosslinking agents (corresponding to the crosslinking groups), an allyl sulfide, a stabilizing agent (corresponding to the stabilizing group) and an aliphatic group. The weight percents of the polysulfide, crosslinking agents, aliphatic groups and stabilizing agents in the mixture may be the same as in the final sulfur polymer described above.

As described previously, the mixture may comprise an allyl sulfide. The present inventors have found that, while polysulfides generally are unreactive with hydrophilic reagents, the allyl sulfide may serve as a compatibilizer between the polysulfides and the other constituents of the sulfur polymer. In embodiments of the present disclosure, the allyl sulfide may comprise a diallyl sulfide, such as a diallyl disulfide. The diallyl disulfide may, under heating, form sulfide radicals. These sulfur radicals can react with the sulfur radicals of the polysulfides. Additionally, the double bonds of the allyl sulfides can react with the aliphatic group and/or the crosslinking agent to link the polysulfide chain to the rest of the polymer.

In embodiments of the present disclosure, the allyl sulfide may be present in the mixture at a weight percent of from 5 wt. % to 30 wt. %, such as from 10 wt. % to 20 wt. %. Further, a weight ratio of the polysulfides to the allyl sulfide may be from 1.5 to 5.5, such as from 2.0 to 4.5 such as from 2.5 to 4.0.

Furthermore, the polysulfides may be present in the mixture in a specific weight ratio with the crosslinking agents, such from 0.5 to 4, such as 1 to 2.

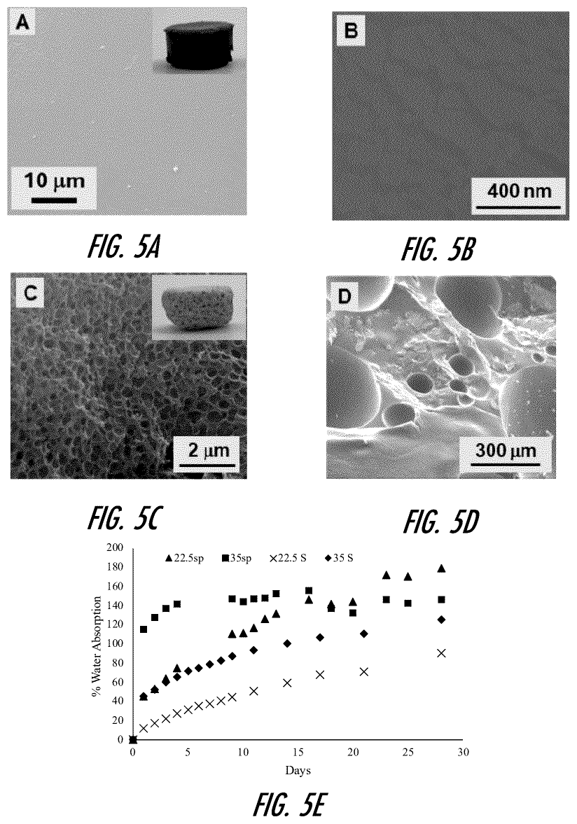

In embodiments, it may be desirable for the sulfur polymer to be porous. In such embodiments, a porogen may be added to the mixture. Such a porogen may comprise a non-reactive powder. The non-reactive powder may comprise an ionic salt, such as salts of chlorides, bromides. Without wishing to be limited, such salts may have a cation of sodium, potassium, calcium, magnesium, or aluminum. An ionic salt may be desirable to use to increase the porosity of the sulfur polymer, as it can be washed out subsequent to formation of the sulfur polymer. Alternatively, the non-reactive powder may comprise a mineral powder, such as a powder of silica, alumina, mica, talc, or combination thereof. FIGS. 5A-5B are SEM photographs of the 35 wt. % polysulfide polymer without any porogens. FIGS. C and D are SEM photographs of 35 wt. % polysulfide polymers having NaCl and NaHCO₃, respectively. FIG. 5E is a graph showing the max water absorption % of the sulfur polymers formed with and without porogens. As can be seen from FIG. 5E, the sulfur polymers formed with porogens absorbed greater amounts of water than those formed without porogens.

In embodiments of the present disclosure, the sulfur polymers of the present disclosure may be formed using inverse vulcanization. Thus, in embodiments, the method may comprise forming a mixture of reagents and subjecting the mixture to temperatures sufficient to induce inverse-vulcanization of the polysulfides. By inverse-vulcanization, the polysulfide chains break to form polysulfide radicals, which thereby begin the reaction between the polysulfides, aliphatic groups and crosslinking agents. Further, the temperature at which inverse-vulcanization occurs may be sufficient to melt the solid sulfur, which can act as a reaction medium for the mixture.

The synthesis of the sulfur polymer of the present disclosure may involve the heating of the reagents—polysulfides, allyl sulfides, stabilizing agents, crosslinking agents and aliphatic groups—to initiate inverse-vulcanization. The heating may comprise heating the mixture to a temperature from 110 degrees Celsius to 180 degrees Celsius, such as from 120 degrees Celsius to 160 degrees Celsius, such as from 130 degrees Celsius to 150 degrees Celsius. In some embodiments of the present disclosure, heating may comprise heating the reaction mixture to a temperature from 120 degrees Celsius to 140 degrees Celsius.

Further, the mixture may be heated for a period of time sufficient to allow the mixture to fully react. Such a period of time may be from 20 minutes to 4 hours, such as from 30 minutes to 3 hours, such as from 1 to 2 hours. Without wishing to be limited, as the concentration of sulfur in the mixture increases, the mixture may be heated for a shorter period of time.

Thereafter, the sulfur polymer may be cured. The curing step may take place in the same vessel as used for the initial reaction of the mixture. Alternatively, the mixture may be introduced into a shape mold for the curing process.

Curing can promote the polymerization and crosslinking of the sulfur polymer. The curing temperature, and duration thereof, are subject to modification depending on the concentration of the monomers used in the initial mixture.

The curing temperature may range from 70 degrees Celsius to 150 degrees Celsius, such as from 90 degrees Celsius to 140 degrees Celsius, such as from 100 degrees Celsius to 130 degrees Celsius.

Sulfur polymers containing low concentrations of sulfur may have a longer curing time, whereas high sulfur polymers may have a shorter curing time. In general, the curing time may be from 1 hour to 1 day, such as from 2 hours to 12 hours. In embodiments, the curing time may be from 1 hour to 2 hours. While subject to vary by the concentration of various monomers within a sulfur polymer, the curing time can be used to control the degree of polymerization and crosslinking in the final sulfur polymer. While a fully cured sulfur polymer may have excellent strength characteristics, the increased molecular rigidity may not allow for as great water absorption as compared to a less crosslinked sulfur polymer.

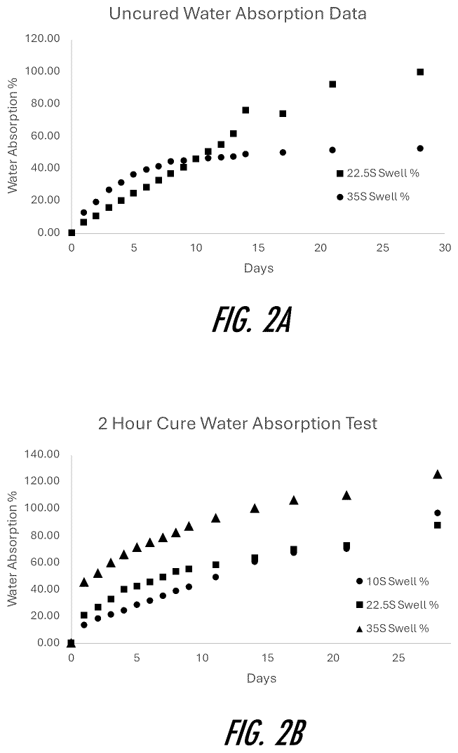

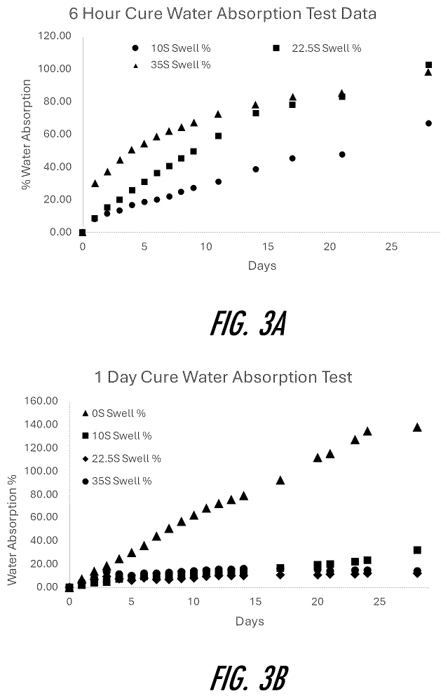

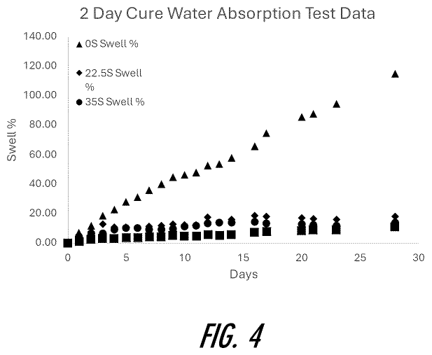

FIGS. 2A-4 show the maximum water absorption for sulfur polymers with various sulfur concentrations subjected to different curing times. As shown in Table 1 below, different curing times can be used for different sulfur polymers to obtain a high water absorption %.

| Weight | Cure | Water |
|---|---|---|
| % | Time | Absorption |
| Sulfur | (hours) | % |
| 0 | 24 | 138.1 |
| 12 | 6 | 117.8 |
| 22.5 | 6 | 90.5 |
| 35 | 2 | 125.5 |

As can be seen above in Table 1, a general correlation between increased polysulfide content and decreased cure times has been found. Further, cure times are discussed in the Examples below.

After curing, the sulfur polymer may be washed with a solvent sufficient to remove unreacted reagents and/or the non-reactive powder. Such a solvent may comprise water. The sulfur polymer may then be dried.

The sulfur polymer may be useful as a hydrogel. A hydrogel can be defined as a polymer that can absorb at least its weight in water. Thus, the sulfur polymer of the present disclosure may be described as a sulfur hydrogel when laden with water. Further, the “% water absorption” of the sulfur hydrogel may refer to the maximum wt. % of water in a sulfur hydrogel.

In embodiments of the present disclosure, a hydrogel may comprise an intermediate hydrogel. An intermediate hydrogel may be able to absorb 80% to 200% of its weight in water, such as from 90% to 150% of its weight in water.

In embodiments of the present disclosure, the hydrogel may comprise a high-absorbing hydrogel. A high-absorbing hydrogel may be able to absorb greater than 100% of its weight in water, such as greater than 200% of its weight in water, such as greater than 400% of its weight in water. In other words, the high-absorbing hydrogel may be to absorb from 200% to 600% of its weight in water, such as from 300% to 500% of its weight in water.

The sulfur polymer of the present disclosure may be powdered. In such embodiments, the sulfur polymer powder may have a D50 of from 100 microns to 500 microns, such as from 200 to 400 microns. For some uses, such as in environmental remediation, it may be desirable to employ the sulfur polymer in the form of as a powder, which can ease its distribution across a soil surface in need of remediation.

As stated previously and in the Background, an intent of the present disclosure is to provide a means by which sulfur may be introduced into a soil. Such a method may comprise providing the sulfur polymer to a soil. Such a soil is not particularly limited, but may comprise a soil that is depleted in sulfur. The soil may then be tilled to incorporate the sulfur polymer. Further, the sulfur polymer may be provided in the form of a dry polymer, a semi-absorbed polymer, or a fully-absorbed polymer. When incorporated as the un-hydrated sulfur polymer powder, the sulfur polymer powder may be incorporated into the soil at a concentration from 8 ounces per cubic foot and 5 pounds per cubic foot, such as from 12 ounces per cubic foot and 2 pounds per cubic foot.

The present invention may be better understood with reference to the examples set forth below.

### Formation of Sulfur Polymers

Samples were formed out of the reagents shown below in Table 2, where the values are in weight percent (S=sulfur, GEO=garlic essential oil (the primary component of which is diallyl disulfide), MA=methacrylamide, DMA=dimethacrylamide, MBA=methylbisacrylamide). Each sample was prepared on a one-gram scale by mixing all of the reagents, and heating in a round bottom flask. The samples were then heated to a temperature from 120 degrees Celsius to 160 degrees Celsius for between 0.4 hours and 3 hours.

| Sample | S | GEO | MA | DMA | MBA |
|---|---|---|---|---|---|
| Sample 1 | 5 | 25 | 30 | 15 | 25 |
| Sample 2 | 10 | 20 | 25 | 15 | 30 |
| Sample 3 | 20 | 20 | 25 | 5 | 30 |
| Sample 4 | 25 | 15 | 20 | 10 | 25 |
| Sample 5 | 35 | 10 | 20 | 10 | 25 |
| Sample 6 | 45 | 5 | 20 | 5 | 25 |

Thereafter, samples were poured into molds and cured at 120 degrees Celsius for three days.

Water absorption tests were performed by first weighing the sample post-cure. The samples were then submerged in a water bath until repeated weightings showed that the mass of the hydrogel stopped increasing. The water absorption % was then calculated as the difference between the initial sulfur polymer mass and the final sulfur hydrogel mass, divided by the initial sulfur polymer mass, times 100. The results of the water absorption test are shown below in Table 3.

| | Sample | Sample | Sample | Sample | Sample | Sample |
|---|---|---|---|---|---|---|
| Sample | 1 | 2 | 3 | 4 | 5 | 6 |
| Water | 597% | 252% | 32% | 69% | 106% | 221% |
| Absorption | | | | | | |
| % | | | | | | |

### IV Temperature and Duration Studies

To find the optimal reaction times for the 35 wt. % polysulfide and 22.5 wt. % polysulfide polymers, samples were heated at 120° C. and 140° C. until the polymer completely vitrified in the reaction vial. All polymers synthesized at both temperatures had full incorporation of sulfur and no MBA crystallization. At 120° C., vitrification took over 3 hours for the 22.5 wt. % polysulfide sample and over 2 hours for the 35 wt. % polysulfide sample. At 140° C., the 22.5 wt. % polysulfide and 35 wt. % polysulfide samples vitrified after 2.25 hours and 1.25 hours respectively. The higher reaction temperatures were chosen due to the lower vitrification time. The final reaction times were slightly decreased from the vitrification times to ensure that the polymer mixtures could still be poured into molds after synthesis. Reaction times for the 22.5 wt. % polysulfide and 35 wt. % polysulfide samples were chosen to be 1.75 hours and 55 minutes respectively. Optimal reaction times for the 0 wt. % polysulfide and 10 wt. % polysulfide samples were determined in the same fashion, but all three reaction temperatures were tested. The 0 wt. % polysulfide syntheses at 120° C. and 140° C. were suspended after a full 24 hours of reacting in the oil bath without vitrification. This sample did vitrify after 3.5 hours at 160° C., so that reaction temperature was selected with a 3-hour reaction time. The 120° C. synthesis for the 10 S sample was also suspended with no vitrification after 24 hours. However, this sample vitrified during the 140° C. and 160° C. syntheses after 4 hours and 1.25 hours respectively. Just like the 22.5 wt. % polysulfide and 35 wt. % polysulfide samples, a 160° C. synthesis temperature and a 1-hour reaction time were chosen for the 10 wt. % polysulfide sample due to the lower vitrification time. A table showing the samples composition and corresponding reaction temperature and time can be found below in Table 4.

| | | | | | | | Reaction |
|---|---|---|---|---|---|---|---|
| | | | | | | Temperature | Time |
| Sample | S | GEO | MA | DMA | MBA | (° C.) | (min) |
| Sample | 35 | 10 | 20 | 5 | 30 | 140 | 55 |
| 1 | | | | | | | |
| Sample | 22.5 | 22.5 | 20 | 5 | 30 | 140 | 105 |
| 2 | | | | | | | |
| Sample | 10 | 35 | 20 | 5 | 30 | 160 | 60 |
| 3 | | | | | | | |
| Sample | 0 | 45 | 20 | 5 | 30 | 160 | 165 |
| 4 | | | | | | | |

### Curing Studies

Now that reaction temperatures and times had been selected for the various poly (PS-DADS-MA) polymers, the next goal was to optimize the cure time to find a balance between extent of polymerization and water absorption. Preliminary research found that a 5-day curing period minimized the water absorption capacity of the sulfur polymers. On the other hand, if the extent of polymerization is too low, the polymer matrix would lack structural integrity and may cause the hydrogel to lose its shape or leach in water. Testing was conducted to find balanced cure times for each of the samples that would allow the extent of polymerization to remain high enough to promote shape retention and prevent leaching but not so high that water absorption was inhibited. To begin the cure time optimization, all polymers from Table 4 were synthesized and cured for different lengths of time (uncured, 2 h, 6 h, 8 h, 1 day, 2 days). To determine how extent of polymerization affects the water absorption of these polysulfides, each sample type was subjected to an extended 28-day water absorption test. These tests were conducted in triplicate for each sample, and water absorption was tracked daily for the first 9 days with additional measurements taken on days 11, 14, 17, 21, and 28. Water absorption ratios are reported as an average of the three samples. Samples were weighed prior to transferring to small beakers filled with DI water to get an initial mass for each polymer. When the swollen polymers were measured, the samples were removed from their beakers, lightly patted dry with paper towels to remove any water adhered to the surface, weighed, and placed back in their beakers. The 10 wt. % polysulfide samples are not included in the uncured water absorption data due to poor shape retention in water at that cure time, causing these samples to adhere to the beakers during submersion in water, making it impossible to record accurate masses. The 0 wt. % polysulfide samples are missing from the uncured, 2 h cure, and 6 h cure water absorption tests for the same reason. These data indicate, for lower sulfur content samples, longer cure times were needed. Although the 22.5 wt. % polysulfide samples had optimum absorption without any cure, these samples had poor shape retention, so the 6 h cure produced the best results. Water absorption of the 22.5 wt. % polysulfide polymer decreased significantly going from a 6 h cure to a 1-day cure, indicating that the extent of polymerization was too high for that cure time. Following a similar trend, the 35 wt. % polysulfide samples had better water absorption at lower cure times with the 2 h cure being the highest. Results of the water absorption studies can be found in FIGS. 2A-4.

### Bacteria Studies

Additionally conducted were experiments testing the effect that sulfur hydrogels had on various microbes, including P. aeruginosa. P. aeruginosa was chosen for evaluation, as it is a bacteria which supports several important functions in a soil ecosystem. For instance, P. aeruginosa enhances the immune system of plants, attacks pathogens, and form protective biofilms around plant roots.

As controls, cultures of P. aeruginosa were formed without the presence of any polymers. Further, polymers were formed without the presence of any P. aeruginosa. As experimental samples, porous and non-porous sulfur polymers were prepared. For experimental samples, sulfur polymers were washed, sterilized and dried. The masses of the dried sulfur polymers were recorded. The sulfur polymers were then placed into 50 mL of media and 50 μL of P. aeruginosa culture. The cell growth of P. aeruginosa was then tracked by measuring the optical density at 600 nm.

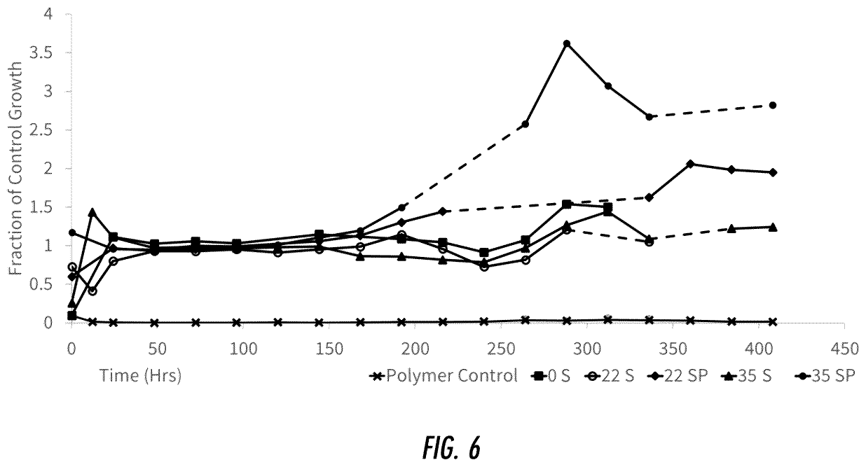

As can be seen in FIG. 6, the porous (denoted as SP) sulfur polymers had the highest fraction of cell growth as normalized to the control cell growth. Nonetheless, the sulfur polymers formed with no porogen had a higher cell growth as compared to the control.

After the conclusion of the experiment (longest sample ran for 400 hours), the sulfur polymers were removed from the media, washed with 2% SDS, and dried. The final weight of the polymer was compared to the initial weight of the polymer.

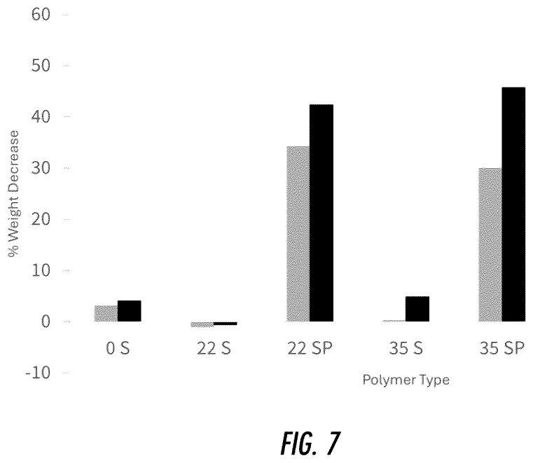

The difference in weight between the initial weight of the polymer and the final weight of the polymer is equivalent to the mass of the polymer that was degraded by P. aeruginosa, minus any mass loss of the control sample. As can be seen in FIG. 7, the sulfur polymers generally experienced a weight loss greater than the control sample, which corresponds to the left gray bar.

Without wishing to be bound to any particular theory, it is believed by the present inventors that P. aeruginosa can promote the degradation of the sulfur polymers of the present disclosure, thereby increasing the availability of sulfur in soil.

While certain embodiments of the disclosed subject matter have been described using specific terms, such description is for illustrative purposes only, and it is to be understood that changes and variations may be made without departing from the spirit or scope of the subject matter.

What is claimed is:

1. A sulfur polymer comprising:
a polysulfide chain;
an aliphatic group; and
a stabilizing group.

2. The sulfur polymer of claim 1, further comprising crosslinking groups, wherein the crosslinking groups are bonded to aliphatic group.

3. The sulfur polymer of claim 1, wherein the aliphatic group comprises an amide.

4. The sulfur polymer of claim 1, wherein the sulfur polymer comprises a weight percent of sulfur of 10 wt. % to 65 wt. %.

5. The sulfur polymer of claim 1, wherein the sulfur polymer comprises a weight percent of sulfur of 20 wt. % to 55 wt. %.

6. The sulfur polymer of claim 2, wherein a molar ratio of the crosslinking groups to the stabilizing group is 1.5 to 3.5.

7. A method for forming a sulfur polymer, the method comprising:
heating a mixture comprising polysulfides, a crosslinking agent, a diallyl sulfide, a stabilizing agent and an aliphatic group.

8. The method of claim 7, wherein a weight ratio of the polysulfides to the diallyl sulfide is from 1.5 to 5.5.

9. The method of claim 7, wherein a weight ratio of the polysulfides to the diallyl sulfide is from 2.5 to 4.

10. The method of claim 7, wherein a weight ratio of the polysulfides to the crosslinking agent is from 1 to 2.

11. The method of claim 7, wherein the diallyl sulfide comprises diallyl disulfide.

12. The method of claim 7, wherein the stabilizing agent comprises dimethylacrylamide.

13. The method of claim 7, further comprising adding an ionic salt to the mixture.

14. The method of claim 7, wherein the mixture is heated to a temperature from 110 degrees Celsius to 180 degrees Celsius.

15. The method of claim 14, wherein the mixture is cured after heating.

16. A method of incorporating sulfur into a soil, the method comprising adding the sulfur polymer of claim 1 to soil.

17. The method of claim 16, wherein the sulfur polymer is in the form of a powder.
